(19) United States
(12) Patent Application Publication
(10) Pub. No.: US 2024/0140266 A1
(43) Pub. Date: May 2, 2024

(54) MANAGEMENT METHOD AND COMPUTER DEVICE

(71) Applicant: TOYOTA JIDOSHA KABUSHIKI KAISHA, Toyota-shi (JP)

(72) Inventors: Yuko TERASAWA, Nerima-ku (JP); Makoto Kakuchi, Toyota-shi (JP); Toshiaki Karasawa, Adachi-ku (JP); Takeshi Higashi, Nagoya-shi (JP); Yoshihiko Endo, Minato-ku (JP)

(73) Assignee: TOYOTA JIDOSHA KABUSHIKI KAISHA, Toyota-shi (JP)

(21) Appl. No.: 18/498,316

(22) Filed: Oct. 31, 2023

(30) Foreign Application Priority Data
Nov. 2, 2022 (JP) 2022-176352

(51) Int. Cl. B60L 58/16; G06Q 10/20; G06Q 30/0645; G07C 5/00

(52) U.S. Cl. CPC B60L 58/16; G06Q 10/20; G06Q 30/0645; G07C 5/006; B60L 2250/16; B60L 2250/30

(57) ABSTRACT

A management method for a power storage device includes: when a discharging request for energy management is received, determining (S172) whether or not a degree of deterioration of a power storage device is larger than a first reference value with regard to a battery lease vehicle (vehicle including a power storage device having been lent); and based on a result of the determination, instructing (S18) the battery lease vehicle in which the degree of deterioration of the power storage device is smaller than the first reference value, to perform discharging to outside of the vehicle in accordance with the discharging request, and not instructing the battery lease vehicle in which the degree of deterioration of the power storage device is larger than the first reference value, to perform discharging in accordance with the discharging request.

This nonprovisional application is based on Japanese Patent Application No. 2022-176352 filed on Nov. 2, 2022 with the Japan Patent Office, the entire contents of which are hereby incorporated by reference.

### BACKGROUND

### Field

The present disclosure relates to a management method of a power storage device and a computer device.

### Description of the Background Art

Japanese Patent Laying-Open No. 2020-177652 discloses a technique in which a server that manages a lending fee paid by a user for lending a running battery mounted on a vehicle collects a full charge capacity of the battery from the vehicle and lowers the lending fee as the collected full charge capacity decreases.

### SUMMARY

Since the value of the power storage device decreases as the full charge capacity of the power storage device decreases due to deterioration of the power storage device, in the technique described in Japanese Patent Laying-Open No. 2020-177652, the lending fee decreases as the full charge capacity decreases. However, in such a technique, the lending fee becomes lower as the power storage device deteriorates. Therefore, the user is not given an incentive to avoid deterioration of the power storage device in using the power storage device. In addition, the user is unlikely to understand what usage facilitates deterioration of the power storage device. Therefore, there is a possibility that the user unconsciously deteriorates the power storage device excessively. If the power storage device having been lent is deteriorated too much, it becomes difficult for a lease provider to reuse the returned power storage device for other applications.

The present disclosure has been made to solve the above-mentioned problem, and an object of the present disclosure is to suppress a power storage device having been lent from being excessively deteriorated.

According to a first aspect of the present disclosure, there is provided a management method for a power storage device, the management method including: in response to receiving a discharging request for first energy management, determining, with regard to a vehicle including a power storage device having been lent, whether or not a degree of deterioration of the power storage device is larger than a first reference value; and based on a result of the determination, instructing the vehicle in which the degree of deterioration of the power storage device is smaller than the first reference value, to perform discharging to outside of the vehicle in accordance with the discharging request, and not instructing the vehicle in which the degree of deterioration of the power storage device is larger than the first reference value, to perform discharging in accordance with the discharging request.

Normally, electric power is stored into a power storage device mounted on a vehicle by external charging (charging of the power storage device by electric power from the outside of the vehicle) whenever electric power is consumed by use of the vehicle. Therefore, there is a high possibility that external charging is routinely performed. On the other hand, external power feeding (discharging from the power storage device to outside of the vehicle) is performed less frequently onto the power storage device mounted on the vehicle. Therefore, such a power storage device mounted on the vehicle tends to have high resistance to external charging but have relatively low resistance to external power feeding.

In the above-described management method, a discharging command (external power feeding command) for energy management is not transmitted to the vehicle in which the degree of deterioration of the power storage device having been lent is large. This makes it possible to suppress the power storage device having been lent from being excessively deteriorated. On the other hand, the vehicle in which the degree of deterioration of the power storage device having been lent is low can contribute to the energy management in accordance with the discharging command (external power feeding command) for the energy management. Therefore, it is possible to achieve both the suppression of deterioration of the power storage device having been lent and fulfillment of the request in the energy management.

The vehicle including the power storage device may be an electrically powered vehicle (xEV) that uses electric power as a whole or part of a motive power source. Examples of the xEV include a battery electric vehicle (BEV), a hybrid electric vehicle (HEV), a plug-in hybrid electric vehicle (PHEV), and a fuel cell electric vehicle (FCEV).

According to a second aspect of the present disclosure, there is provided a computer device including: a processor; and a storage device that stores a program for causing the processor to perform the above-described management method for a power storage device. According to such a computer device, the above-described management method is suitably performed.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating an outline of a management system of a power storage device according to an embodiment of the present disclosure.

FIG. 2 is a diagram for explaining the configuration of the vehicle shown in FIG. 1.

FIG. 3 is a diagram showing a schematic configuration of an energy management system according to an embodiment of the present disclosure.

FIG. 4 is a flowchart showing control for causing a vehicle to execute energy management in the management method of the power storage device according to the embodiment of the present disclosure.

FIG. 5 is a flowchart showing details of energy management control relating to a sales vehicle in the management method of the power storage device according to the embodiment of the present disclosure.

### DESCRIPTION OF THE PREFERRED EMBODIMENTS

Embodiments of the present disclosure will be described in detail with reference to the drawings. In the drawings, the same or corresponding parts are denoted by the same reference numerals, and the description thereof will not be repeated.

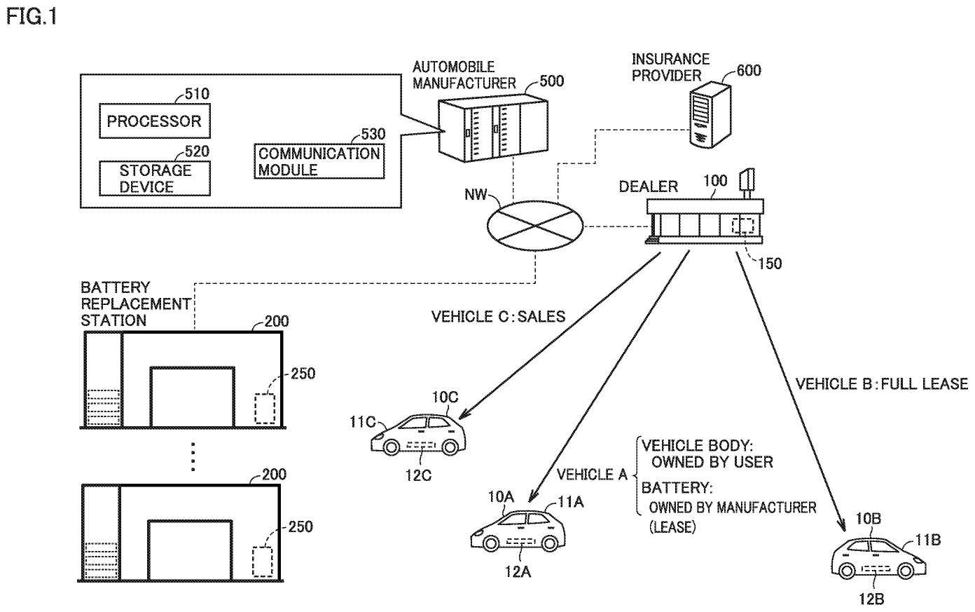

FIG. 1 is a diagram illustrating an outline of a management system of a power storage device according to an embodiment. The management system includes a dealer 100, a battery replacement station (hereinafter referred to as “BSta”) 200, a management center 500, and an insurance server 600.

The management center 500 is a server that provides a lease service for lending a vehicle power storage device. The management center 500 manages information on lease services. The management center 500 belongs to, for example, an automobile manufacturer. In this embodiment, the automobile manufacturer also serves as a lease provider. The insurance server 600 is a server that provides an insurance service. The insurance service is, for example, a service for compensating for deterioration of a power storage device mounted on a vehicle.

The vehicle manufacturer sells or releases the manufactured vehicle through the dealer 100. In this embodiment, a plurality of types of lease methods including the partial lease method and the full lease method are adopted. The dealer 100 includes a server 150. The server 150 manages the information (vehicle information) related to the vehicle sold or leased by the dealer 100 by distinguishing the information from the vehicle ID. The server 150 sequentially transmits the latest vehicle information to the management center 500. The dealer 100 may lend the power storage device 12A of the vehicle 10A (vehicle A) shown in FIG. 1 to the user by, for example, a partial lease method. In the vehicle 10A (partially leased vehicle), the vehicle body 11A is owned by the user, and the power storage device 12A is owned by the automobile manufacturer. The dealer 100 may lend the vehicle 10B (vehicle B) shown in FIG. 1 to the user by, for example, the full lease method. In the vehicle 10B (full-leased vehicle), all of the vehicles (the vehicle body 11B and the power storage device 12B) are owned by the automobile manufacturer. The dealer 100 may sell the vehicle 10C (vehicle C) shown in FIG. 1 to a user. In the vehicle 10C (sales vehicle), all of the vehicles (the vehicle body 11C and the power storage device 12C) are owned by the user.

In this embodiment, the insurance fee is included in the lease fee (e.g., monthly lease fee) charged by the dealer 100 to the vehicle user. That is, each of the vehicles A and B subscribes to the insurance provided by the insurance server 600. The insurance is applied when power storage devices mounted on these vehicles deteriorate. The insurance service enables, for example, a vehicle user to replace a power storage device with no charge. Since the insurance is for lease, the vehicle C does not subscribe to the insurance. However, the vehicle C may subscribe to another insurance.

In this embodiment, a plurality of dealers 100 (only one of which is shown) and a plurality of BSta 200 are installed so as to cover the entire jurisdiction area of the management system of the power storage device. The BSta 200 is configured to replace a power storage device for a vehicle. The BSta 200 includes a server 250. The power storage device lent to the vehicle user through the dealer 100 by the vehicle manufacturer is returned from the vehicle user to the BSta 200. In this embodiment, a secondary battery is adopted as the power storage device. Note that the power storage device may be any device as long as it can store power.

The management center 500 includes a processor 510, a storage device 520, and a communication module 530. The processor 510 includes, for example, a CPU (Central Processing Unit). The storage device 520 is configured to store written (inputted) information. The communication module 530 is connected to the communication network NW by wire, for example. Each of the server 150 and the server 250 is also connected to the communication network NW by wire, for example. The management center 500, the insurance server 600, the server 150, and the server 250 are configured to be able to communicate with each other via the communication network NW. The communication network NW is, for example, a wide area network constructed by the Internet and a radio base station.

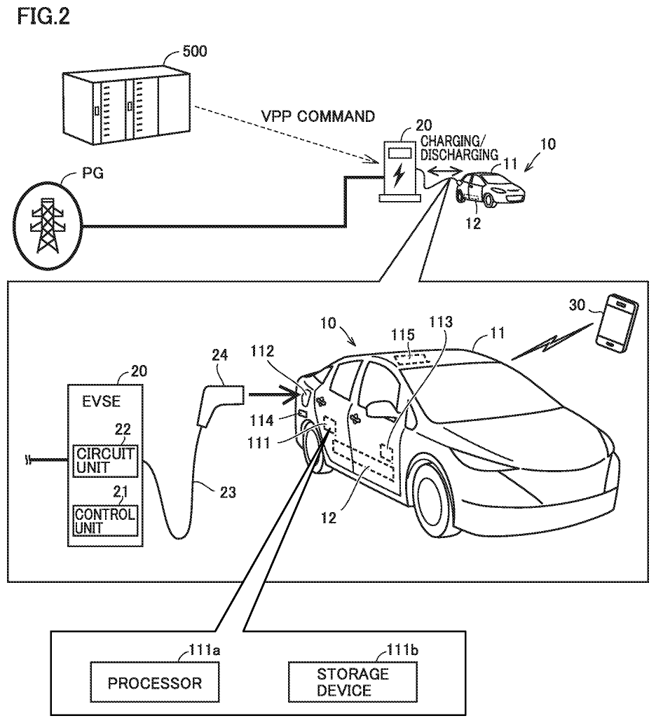

Hereinafter, the vehicle provided by the dealer 100 may be referred to as a “vehicle 10”. The vehicle 10 according to this embodiment is one of the vehicles A, B, and C shown in FIG. 1. FIG. 2 is a diagram illustrating a configuration of the vehicle 10.

Referring to FIG. 2, vehicle 10 includes a vehicle body 11 and a battery 12 mounted on vehicle body 11. The vehicle 10 may be a BEV having no internal combustion engine or a PHEV having an internal combustion engine. As the battery 12, a well-known power storage device for a vehicle (e.g., a lithium ion secondary battery or a nickel hydrogen secondary battery) can be adopted. A plurality of secondary batteries may form a battery assembly. The battery 12 corresponds to an example of the “power storage device” according to the present disclosure.

The vehicle body 11 includes an ECU 111, an inlet 112, a charge/discharge circuit 113, a discharge port 114, and a communication device 115. The vehicle body 11 further includes HMI (Human Machine Interface) and BMS (Battery Management System) (not shown). The ECU 111 is a computer including a processor 111a and a storage device 111b. The storage device 111b stores a program to be executed by the processor 111a. The ECU means an electronic control unit. Power is supplied from an auxiliary battery (not shown) to a control system (including the ECU 111) of the vehicle 10.

The storage device 111b further stores information (battery information) relating to the battery 12 mounted on the vehicle 10. The battery information includes the state (e.g., temperature, current, voltage, SOC, and SOH) of the battery 12 detected by the BMS. SOC (State Of Charge) indicates the remaining charge amount. SOH (State of Health) indicates the degree of health or deterioration of the power storage device. Examples of SOH include capacity retention and internal resistance. The larger the internal resistance of the power storage device, the greater the degree of deterioration of the power storage device. The lower the capacity retention ratio of the power storage device, the greater the degree of deterioration of the power storage device. The capacity retention ratio corresponds to the ratio of the current capacity to the capacity in the initial state (non-deterioration state). The capacity of the power storage device corresponds to the amount of power stored in the fully charged state.

EVSE means an electric vehicle supply equipment. The body of the EVSE 20 incorporates a control unit 21 and a circuit unit 22. The EVSE 20 further comprises a charging cable 23 extending outward from the body of the EVSE 20. The charging cable 23 is electrically connected to the circuit unit 22. The control unit 21 includes a processor and a storage device, and is configured to communicate with the management center 500. The circuit unit 22 includes a circuit for supplying power to the vehicle 10 and a circuit for supplying power to the power system PG (reverse power flow).

The inlet 112 is configured such that a connector 24 (tip portion) of the charging cable 23 can be attached/detached. The inlet 112 functions as a charge/discharge port. When the connector 24 of the charging cable 23 connected to the body of the EVSE 20 is connected to the inlet 112 of the vehicle 10 in the parked state, the vehicle 10 is electrically connected to the EVSE 20 (plug-in state). On the other hand, for example, while the vehicle 10 is traveling, the vehicle 10 is not electrically connected to the EVSE 20 (plug-out state). The EVSE 20 further includes a connection detection circuit (not shown) for detecting a state (plug-in state/plug-out state) of the connector 24.

The EVSE 20 and the power system PG are electrically connected to each other. Therefore, the vehicle 10 in the plug-in state is electrically connected to the power system PG. When the vehicle 10 in the plug-in state performs external charging (charging of the battery 12 by power from the outside of the vehicle), power supplied from the power system PG is output to the connector 24 through the circuit unit 22 of the EVSE 20 and input to the inlet 112. The charge/discharge circuit 113 uses the power supplied from the inlet 112 to generate charging power according to an instruction from the ECU 111, and inputs the generated charging power to the battery 12. When the vehicle 10 in the plug-in state performs external power feeding (discharge from the battery 12 to the outside of the vehicle), the charge/discharge circuit 113 generates feed power according to an instruction from the ECU 111 using power discharged from the battery 12, and outputs the generated feed power to the inlet 112. Then, the electric power output from the vehicle 10 is supplied to the electric power system PG (reverse power flow) through the circuit unit 22 of the EVSE 20. The charge/discharge circuit 113 generates charging power and feed power using a power conversion circuit (for example, at least one of a DC/DC conversion circuit and an AC/DC conversion circuit). For battery 12, resistance to external charging is higher than resistance to external power feeding. For example, the degree of progress of deterioration of the battery 12 by one external charging is smaller than the degree of progress of deterioration of the battery 12 by one external power feeding under the same condition.

In addition to the inlet 112, the vehicle 10 further includes a discharge port 114 for V2H (Vehicle to Home) or V2L (Vehicle to Load) using the power of the battery 12. The charge/discharge circuit 113 switches which of the inlet 112 and the discharge port 114 the electric power from the battery 12 is output in accordance with an instruction from the ECU 111. The ECU 111 may execute V2H or V2L in response to a request from the user. The discharge port 114 may be an outlet for supplying electric power from the battery 12 to a load outside the vehicle.

The communication device 115 includes a communication OF (interface) for accessing the communication network NW by wireless communication. The communication device 115 may include a TCU (Telematics Control Unit) or DCM (Data Communication Module) that performs wireless communication. The communication device 115 further includes a communication OF for performing wireless communication with each of the server 250 and the mobile terminal 30. The ECU 111 is configured to communicate with each of the management center 500, the server 250, and the mobile terminal 30 through the communication device 115. The mobile terminal 30 is carried and operated by a user (a vehicle manager) of the vehicle 10. In this embodiment, a smartphone having a touch panel display is adopted as the mobile terminal 30. The smartphone incorporates a computer and has a speaker function. However, the present disclosure is not limited thereto, and for example, a laptop, a tablet terminal, a portable game machine, a wearable device, an electronic key, and the like can be adopted as the mobile terminal 30.

Application software (hereinafter referred to as a “mobile application”) for using a service provided by the management center 500 is installed in the mobile terminal 30. By the mobile application, the identification information (terminal ID) of the mobile terminal 30 is registered in the management center 500 in association with the identification information (vehicle ID) of the corresponding vehicle 10. The mobile terminal 30 can exchange information with the management center 500 through the mobile application.

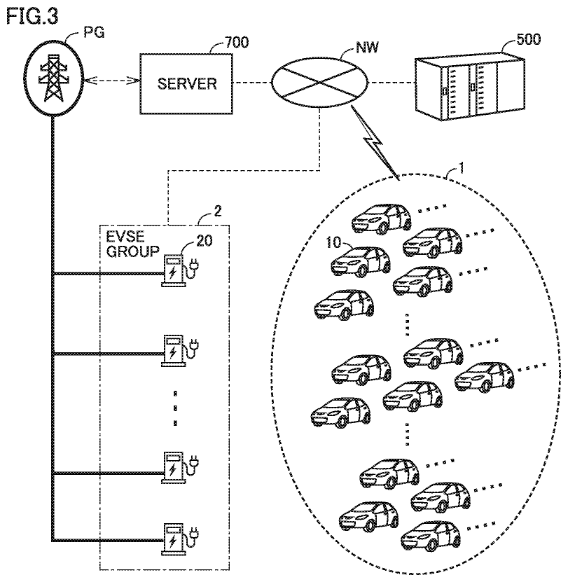

FIG. 3 is a diagram showing a schematic configuration of an energy management system according to this embodiment. Referring to FIG. 3 together with FIG. 1 and FIG. 2, the management center 500 functions as an aggregator and performs energy management of the power system PG in cooperation with the vehicle group 1 and the EVSE group 2. The management center 500 is configured to be able to communicate with each of the vehicle group 1, EVSE group 2, and server 700 via the communication network NW.

The power system PG is a power network constructed by power transmission and distribution equipment. A plurality of power plants are connected to the power system PG. The server 700 manages information (including supply/demand balance information) about the power system PG. The vehicle group 1 includes a plurality of vehicles 10. The EVSE group 2 includes a plurality of EVSEs 20 that receive power from the power system PG.

Each EVSE included in the EVSE group 2 is connected to the communication network NW via a communication line, for example. The management center 500 can acquire information (SOC, charging power, discharging power, etc.) about the vehicle 10 and the EVSE 20 by performing wired communication with the vehicle 10 (the vehicle 10 in the plug-in state) connected to the EVSE 20 via the EVSE 20. Further, the vehicle 10 may transmit information to the management center 500 by wireless communication.

Identification information (vehicle ID) of each vehicle included in the vehicle group 1 is registered in the management center 500 in advance. The storage device 520 (FIG. 1) of the management center 500 stores information (vehicle information) related to the vehicle 10 separately by vehicle IDs. The vehicle information includes specifications of the vehicle 10, information indicating whether or not the vehicle 10 is in the plug-in state, information on the vehicle 10 in the plug-in state (for example, the battery information described above), usage mode information, fee information, and incentive information.

The usage mode information indicates the usage mode of the vehicle 10. In this embodiment, the usage mode information indicates one of usage modes of the vehicle A (partially leased vehicle), the vehicle B (full-leased vehicle), and the vehicle C (sales vehicle). For example, when the dealer 100 sells or leases the vehicle 10, the dealer 100 writes usage mode information about the vehicle 10 into a storage device (not shown) of the server 150. Then, the server 150 transmits the usage mode information together with the vehicle ID to the management center 500.

The fee information corresponds to information on a lease fee paid by the vehicle user to the automobile manufacturer. The lease fee corresponds to a fee paid by the user to borrow and use the vehicle or the power storage device. The fee information may indicate the unpaid amount of the lease fee for each vehicle user.

The incentive information corresponds to information about an incentive (e.g., a point) paid by the vehicle manufacturer to the vehicle user who performs energy management in response to a request from the vehicle manufacturer. The incentive information may indicate a total value of points acquired by each vehicle user. The points may be exchangeable with money, items, or rights.

The management center 500 causes the vehicle group 1 to execute energy management of the power system PG, for example, in response to a request from the server 700. Vehicle 10 electrically connected to EVSE 20 may function as DER (Distributed Energy Resources) for VPP (virtual power plant). Specifically, the server 700 requests either a first energy management (e.g., a decrease in demand or an increase in supply) that reduces the proportion of power demand to power supply or a second energy management (e.g., an increase in demand or a decrease in supply) that increases the proportion of power demand to power supply to adjust the balance between supply and demand of the power system PG to the management center 500. When receiving a discharging request for the first energy management or a charging request for the second energy management from the server 700, the management center 500 sends a discharging command or a charging command corresponding to the request to the vehicle 10 in the plug-in state.

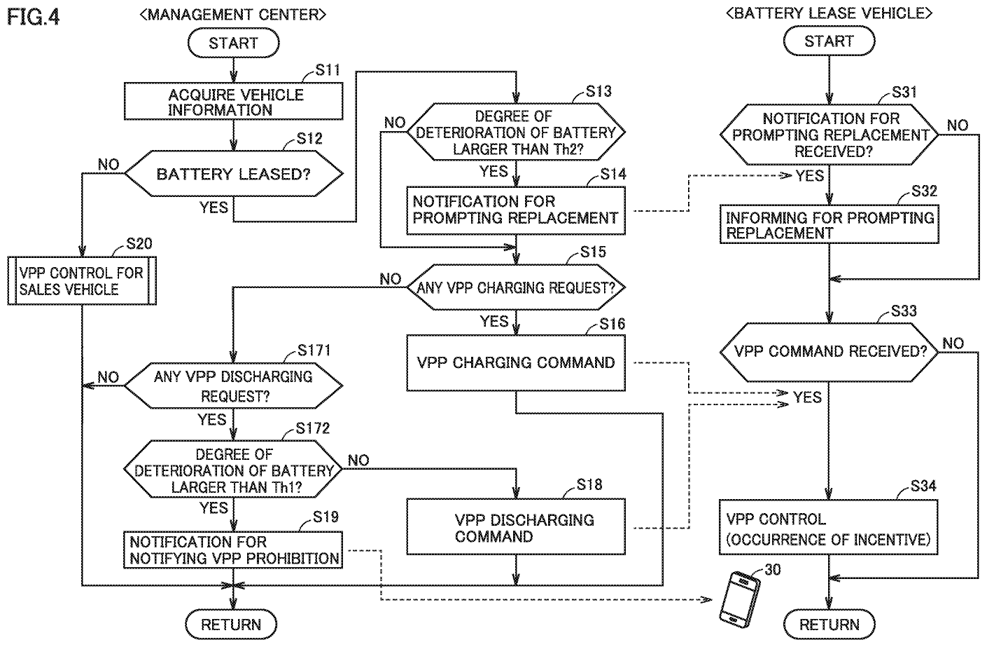

FIG. 4 is a flowchart showing energy management control according to this embodiment. Hereinafter, each step in the flowchart is simply referred to as “S”.

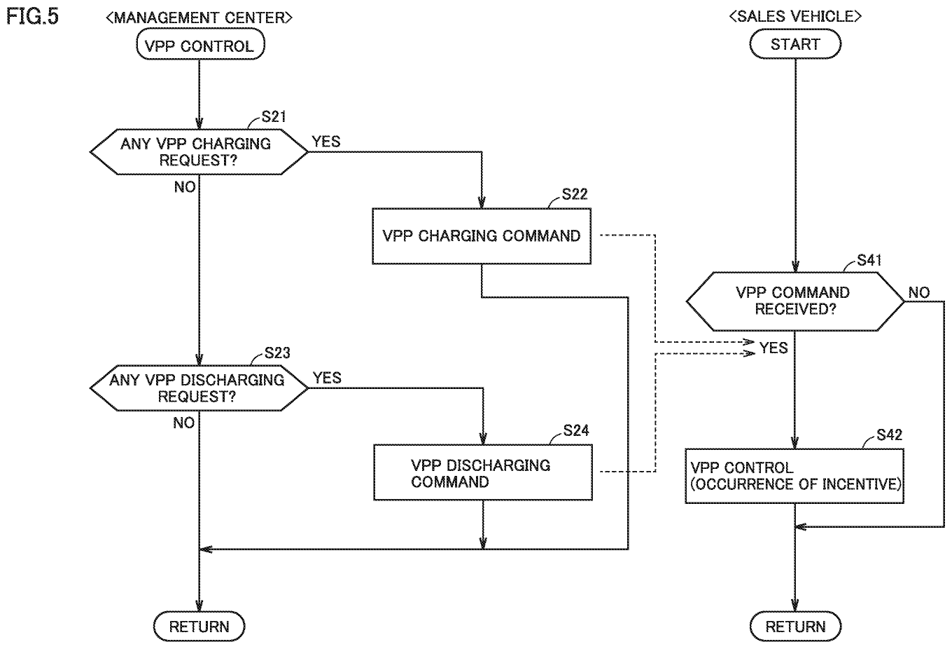

A series of processes (S11 to S20) shown on the left side in FIG. 4 are repeatedly executed at a predetermined cycle by the management center 500. These processes are executed for the vehicle 10 in the plug-in state among the plurality of vehicles (including the vehicles A, B, and C) included in the vehicle group 1 shown in FIG. 3. However, the processing after S13 is executed only for the vehicles A and B, and is not executed for the vehicle C. The processing of S20 (a series of processing of S21 to S24 in FIG. 5 described later) is executed only for the vehicle C, and is not executed for the vehicles A and B. Hereinafter, the vehicle 10 in the plug-in state to be processed by the management center 500 is referred to as a “target vehicle”.

Referring to FIG. 4 together with FIGS. 1 to 3, in S11, the management center 500 acquires vehicle information about the target vehicle from the storage device 520. The management center 500 may request the target vehicle to transmit the vehicle information if necessary.

In S12, the management center 500 determines whether or not the battery 12 mounted on the target vehicle is provided by the lease service. The management center 500 may determine which of the vehicles A to C (FIG. 1) the target vehicle corresponds, for example, using the usage mode information. When the target vehicle is a battery lease vehicle (vehicle A or vehicle B), it is determined that the battery 12 of the target vehicle is provided by the lease service (YES in S12), and the process proceeds to S13. The battery lease vehicle is a vehicle including a lent power storage device.

In S13, the management center 500 determines whether or not the degree of deterioration of the battery 12 mounted on the target vehicle is greater than a predetermined second reference value (hereinafter referred to as “Th2”). The degree of deterioration of the battery 12 may be indicated by the capacity retention rate or internal resistance of the battery 12. When it is determined that the degree of deterioration of the battery 12 is greater than Th2 (YES in S13), the management center 500 notifies the target vehicle that the battery 12 is to be replaced (hereinafter, also referred to as “replacement notification”) in S14. On the other hand, when the degree of deterioration of the battery 12 is equal to or less than Th2 (NO in S13), the processing skips S14 and proceeds to 515.

In S15, the management center 500 determines whether or not a charging request (VPP charging request) for the second energy management of the power system PG is received from the server 700. When the management center 500 receives the VPP charging request (YES in S15), the management center 500 transmits a charging command (VPP charging command) for the second energy management of the power system PG to the target vehicle in S16. When the processing of S16 is executed, the processing returns to S11. While the server 700 continuously transmits the VPP charging request to the management center 500, S16 is repeated, and the transmission of the VPP charging command to the target vehicle is continuously executed. The VPP charging command instructs the target vehicle to perform external charging, and indicates a condition (e.g., charging power corresponding to the VPP charging request) of external charging requested by the target vehicle.

When the management center 500 does not receive the VPP charging request (NO in S15), in S171, the management center 500 determines whether or not a discharging request (VPP discharging request) for the first energy management of the power system PG is received from the server 700. When the management center 500 receives neither the VPP charging request nor the VPP discharging request, NO is determined in S171, and the process returns to S11. In this case, the management center 500 does not transmit a VPP command (instruction for energy management) to the target vehicle.

When the management center 500 receives the VPP discharging request (YES in S171), the management center 500 determines whether or not the degree of deterioration of the battery 12 mounted on the target vehicle is greater than a predetermined first reference value (hereinafter referred to as “Th1”) in S172. Th1 is larger than Th2. When the degree of deterioration of the battery 12 is equal to or less than Th1 (NO in S172), the management center 500 transmits a discharging command (VPP discharging command) for the first energy management of the power system PG to the target vehicle in S18. When the process of S18 is executed, the process returns to S11. While the server 700 continuously transmits the VPP discharging request to the management center 500, the VPP discharging command is continuously transmitted to the battery lease vehicle including the battery 12 whose degree of deterioration is less than or equal to Th1 by the processing of S18. The VPP discharging command instructs external power feeding to the target vehicle and indicates a condition (e.g., discharging power corresponding to the VPP discharging request) of external power feeding required for the target vehicle.

When the degree of deterioration of the battery 12 mounted on the target vehicle is greater than Th1 (YES in S172), the management center 500 notifies the user terminal (for example, the mobile terminal 30) of the target vehicle that external power feeding for energy management is prohibited in S19. Upon receiving this notification, the mobile terminal 30 informs the user of the target vehicle by displaying or sounding that the target vehicle cannot perform energy management. According to such informing, it is possible to further prompt a vehicle user who does not replace the power storage device even when receiving the replacement notification. The user terminal is not limited to a mobile terminal, and may be a vehicle-mounted HMI. When the notification of S19 is executed, the process returns to S11.

In this embodiment, in a battery lease vehicle including a battery 12 having a degree of deterioration greater than Th1, external power feeding for energy management is prohibited, but V2H and V2L are not prohibited. This prevents the user's convenience from being excessively lowered.

A series of processes (S31 to S34) shown on the right side in FIG. 4 is repeatedly executed at a predetermined cycle by each of the vehicles A and B shown in FIG. 1. Each of the vehicles A and B corresponds to a battery lease vehicle. In S31, the ECU 111 of the battery lease vehicle determines whether or not the vehicle has received a replacement notification (S14) from the management center 500. When the vehicle has received the replacement notification (YES in S31), in S32, the ECU 111 controls the user terminal (e.g., the vehicle-mounted HMI or the mobile terminal 30) of the vehicle to prompt the user to replace the battery 12 of the vehicle by displaying or audio (voice and/or sound). After that, the processing proceeds to S33.

The user who is prompted to replace the battery 12 may drive the vehicle 10 toward the BSta 200. When the battery 12 is requested to be replaced from the vehicle 10 by wireless communication, for example, the BSta 200 may fully and automatically execute the requested replacement of the battery 12. The automobile manufacturer may reuse the returned power storage device in an application other than the automobile (for stationary use or the like).

When the vehicle has not received the replacement notification (NO in S31), the processing skips S32 and proceeds to S33. In S33, the ECU 111 determines whether the vehicle receives a VPP command (VPP charging command or VPP discharging command) from the management center 500. When the vehicle receives the VPP command (YES in S33), in S34, the ECU 111 controls the charge/discharge circuit 113 so that external charging or external power feeding of the battery 12 is performed in accordance with the VPP command from the management center 500. When the processing of S34 is executed, the processing returns to S31. While the management center 500 continuously transmits the VPP command to the battery lease vehicle, S34 is repeated, and the ECU 111 executes external charging or external power feeding of the battery 12 so as to satisfy the condition (e.g., charging power or discharging power) indicated by the VPP command. The management center 500 gives an incentive corresponding to the actual performance to the user of the vehicle that has performed charging or discharging according to the VPP command. On the other hand, when the vehicle does not receive the VPP command (NO in S33), the process returns to the first S31 without executing energy management (S34) by the vehicle.

When the target vehicle is the vehicle C, it is determined that the battery 12 of the target vehicle is not provided by the lease service (NO in S12), and the process proceeds to S20 instead of S13. FIG. 5 is a flowchart showing details of energy management control relating to the vehicle C (sales vehicle). A series of processes (S21 to S24) shown on the left side in FIG. 5 corresponds to the process of S20 in FIG. 4.

Referring to FIG. 5 together with FIG. 1 and FIG. 2, in S21 and S22, the management center 500 executes processes according to S15 and S16 of FIG. 4, respectively. In S23 and S24, the management center 500 executes processes according to S171 and S18 of FIG. 4, respectively. When the process of S22 or S24 is executed, the process returns to the flowchart of FIG. 4 at “return”. Thereafter, the processing returns to S21 in the flowchart of FIG. 5 through S11 and S12 of FIG. 4. While the server 700 continuously transmits the VPP charging request or the VPP discharging request to the management center 500 (YES in S21 or S23), S22 or S24 is repeated, and the transmission of the VPP charging command or the VPP discharging command to the target vehicle (vehicle C) is continuously executed. On the other hand, when the management center 500 does not receive a request for energy management from the server 700 (NO in both S21 and S23), the management center 500 does not transmit a VPP command to the target vehicle (vehicle C).

A series of processes (S41, S42) shown on the right side in FIG. 5 is repeatedly executed at a predetermined cycle by the vehicle C shown in FIG. 1. The vehicle C corresponds to a vehicle (selling vehicle) sold to a vehicle user. In S41 and S42, the ECU 111 of the vehicle C executes processes according to S33 and S34 of FIG. 4, respectively. While the management center 500 continuously transmits the VPP command to the vehicle C (YES in S41), S42 is repeated, and the ECU 111 executes external charging or external power feeding of the battery 12 so as to satisfy the condition indicated by the VPP command. The management center 500 gives an incentive corresponding to the actual performance to the user of the vehicle that has performed charging or discharging according to the VPP command. On the other hand, when the vehicle does not receive the VPP command (NO in S41), the process returns to the first S41 without executing energy management (S42) by the vehicle.

As described above, the management method for a power storage device according to the present embodiment includes the processes shown in FIGS. 4 and 5. The management method for a power storage device according to the present embodiment includes: when the management center 500 receives a discharging request for energy management, determining by the management center 500 whether or not a degree of deterioration of a power storage device is larger than a first reference value with regard to a battery lease vehicle (first vehicle including a first power storage device having been lent) (S172 in FIG. 4); based on a result of the determination, instructing by the management center 500 the battery lease vehicle in which the degree of deterioration of the power storage device is smaller than the first reference value, to perform discharging to outside of the vehicle in accordance with the discharging request (S18 in FIG. 4) and not instructing by the management center 500 the battery lease vehicle in which the degree of deterioration of the power storage device is larger than the first reference value, to perform discharging. This makes it possible to achieve both suppression of deterioration of the power storage device having been lent and fulfilment of the request in the energy management.

The management method for a power storage device according to the present embodiment further include: when the management center 500 receives a charging request for second energy management, instructing by the management center 500 the battery lease vehicle to perform charging in accordance with the charging request regardless of the degree of deterioration of the power storage device of the vehicle (S15 and S16 in FIG. 4). This facilitates the user of the battery lease vehicle to perform charging for the energy management.

The management method for a power storage device according to the present embodiment further includes: when the management center 500 receives the discharging request for the first energy management, instructing by the management center 500 a sales vehicle (second vehicle including a second power storage device under an ownership of a user of the second vehicle) to perform discharging to outside of the vehicle in accordance with the discharging request regardless of a degree of deterioration of the power storage device of the vehicle (S23 and S24 in FIG. 5). This facilitates the user of the sales vehicle to contribute to the energy management.

The management method for a power storage device according to the present embodiment further includes: determining by the management center 500 whether or not the degree of deterioration of the power storage device is larger than a second reference value that is smaller than the first reference value with regard to the battery lease vehicle (S13 in FIG. 4); and when it is determined that the degree of deterioration of the power storage device is larger than the second reference value, providing by the management center 500 a user of the battery lease vehicle with a notification for prompting to replace the power storage device (S14 in FIG. 4). In such a method, when the degree of deterioration of the power storage device having been lent exceeds the second reference value that is smaller than the first reference value (the degree of deterioration with which the first energy management is prohibited), the replacement notification is made to the vehicle user. Thus, the vehicle including the power storage device having been lent is facilitated to replace the power storage device before the first energy management is prohibited, thereby suppressing the degree of deterioration of the power storage device having been lent from becoming larger than the first reference value (and also suppressing the first energy management from being prohibited).

In the above embodiment, the management center 500 corresponds to an example of the “computer device” according to the present disclosure. However, the series of processes shown in FIGS. 4 and 5 may be executed by the server 150 (dealer terminal) instead of the management center 500. Each server according to this embodiment is a stationary on-premise server. However, the functions of the servers may be implemented on the cloud by cloud computing.

The processing flow shown in FIGS. 4 and 5 can be changed as appropriate. For example, the order of the processes may be changed or unnecessary steps may be omitted depending on the purpose. Further, the contents of any one of the processes may be changed. For example, in the series of processes shown in FIGS. 4, S13 and S14 may be omitted, or S19 may be omitted.

The lease method may be only one kind of method (for example, partial lease method). In the above embodiment, only the battery is replaced, but the battery pack including the battery and its accessory parts may be collectively replaced. The vehicle may be configured as being wirelessly chargeable. A vehicle that performs wireless charging may be regarded as being in a state conforming to the “plug-in state” described above when alignment of a power transmitting unit (e.g., a power transmitting coil) on the power supply facility side and a power receiving unit (e.g., a power receiving coil) on the vehicle side is completed.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A management method for a power storage device, the management method comprising:
in response to receiving a discharging request for first energy management, determining, with regard to a first vehicle including a first power storage device having been lent, whether or not a degree of deterioration of the first power storage device is larger than a first reference value; and
based on a result of the determination, instructing the first vehicle in which the degree of deterioration of the first power storage device is smaller than the first reference value, to perform discharging to outside of the first vehicle in accordance with the discharging request, and not instructing the first vehicle in which the degree of deterioration of the first power storage device is larger than the first reference value, to perform discharging in accordance with the discharging request.

2. The management method for a power storage device according to claim 1, further comprising:
when the discharging request for the first energy management is received, instructing a second vehicle including a second power storage device under an ownership right of a user of the second vehicle, to perform discharging to outside of the second vehicle in accordance with the discharging request regardless of a degree of deterioration of the second power storage device.

3. The management method for a power storage device according to claim 1, further comprising:
in response to receiving a charging request for second energy management, instructing the first vehicle to perform charging in accordance with the charging request regardless of the degree of deterioration of the first power storage device.

4. The management method for a power storage device according to claim 1, further comprising:
determining whether or not the degree of deterioration of the first power storage device is larger than a second reference value with regard to the first vehicle; and
when it is determined that the degree of deterioration of the first power storage device is larger than the second reference value, providing a user of the first vehicle with a notification for prompting to replace the first power storage device, wherein
the second reference value is smaller than the first reference value.

5. A computer device comprising: a processor; and a storage device that stores a program for causing the processor to perform the management method for a power storage device according to claim 1.
